(19) United States
(12) Patent Application Publication
(10) Pub. No.: US 2024/0314250 A1
(43) Pub. Date: Sep. 19, 2024

(54) MANAGEMENT APPARATUS, CONTROL METHOD FOR MANAGEMENT APPARATUS, AND RECORDING MEDIUM

(71) Applicant: CANON KABUSHIKI KAISHA, Tokyo (JP)

(72) Inventor: SATOSHI NISHIKAWA, Kanagawa (JP)

(21) Appl. No.: 18/596,723

(22) Filed: Mar. 6, 2024

(30) Foreign Application Priority Data
Mar. 15, 2023 (JP) 2023-040226

(51) Int. Cl. H04N 1/00

(52) U.S. Cl. CPC H04N 1/00973; H04N 1/00344; H04N 1/00938; H04N 2201/0094

(57) ABSTRACT

A management apparatus has a first acquisition means configured to acquire firmware that has been selected on a firmware selection screen comprising device information for image processing apparatuses; a storage means configured to store the firmware that has been acquired on a designated storage destination; a receiving means configured to receive a first command for an update to firmware for an image processing apparatus, a second command for setting a schedule for the update, and a setting to automatically acquire the latest firmware at the timing of an update according to the schedule; and a second acquisition means configured to automatically acquire the latest firmware that should be distributed to the image processing apparatus based on the setting to automatically acquire the latest firmware at the timing of the update according to the schedule; wherein the second acquisition means is able to acquire firmware that has not yet been stored on the storage means at the timing of the update according to the schedule.

### BACKGROUND OF THE INVENTION

### Field of the Invention

The present invention relates to a technology that manages a network device including an image processing apparatus, or the like via a network.

### Description of the Related Art

Conventionally, a device management system and management apparatus for acquiring data such as operation information or the like for a device such as a printer, a multi-function peripheral, or the like, and managing this are known. From the points of view of increasing the devices that are management targets, reducing the cost of the management server, and maintenance, the expansion of the scope of the number of devices that can be managed using one management apparatus is seen. In this device management system, it is generally possible to manage the status, device settings, the firmware, and the like, and it is possible to periodically acquire and distribute these, and it is possible to continuously manage devices. In Japanese Patent Laid-Open No. 2021-179929, an arrangement is disclosed that realizes updates to device firmware from an execution results screen using a simple operation.

When creating a firmware distribution task, it is necessary to acquire an image file corresponding to the firmware to be distributed in advance from a storage region (referred to below as a repository) such as a local HDD or the like, and to make it possible to display this on a task creation screen. Therefore, in scheduled distribution, updates using firmware that is newer than the image file that is stored in the repository, such as the latest firmware, are difficult.

### SUMMARY OF THE INVENTION

The present invention provides a management apparatus that is able to acquire the latest firmware in order to distribute the latest firmware to an image processing apparatus.

The management apparatus of the present invention comprises: a memory storing instructions, and a processor executing the instructions causing the management apparatus to: acquire firmware that has been selected on a selection screen for firmware comprising device information for an image processing apparatus; store the firmware that has been acquired on a designated storage location; receive a first command to update the firmware of the image processing apparatus; receive a second command to set a schedule for the update; receive a setting to automatically acquire latest firmware at the timing of the update according to the schedule when the second command has been received; and automatically acquire the latest firmware to be distributed to the image processing apparatus based on the setting to automatically acquire the latest firmware at the timing of the update according to the schedule; wherein the processor is able to acquire firmware that has not yet been stored on the storage means at the timing of the update according to the schedule

Further features of the present invention will become apparent from the following description of exemplary embodiments with reference to the attached drawings.

### BRIEF DESCRIPTION OF THE DRAWINGS

FIG. 1 is a diagram showing a configuration of a device management system.

FIG. 2 is a diagram showing a hardware configuration of a device management server 1000.

FIG. 3 is a diagram showing a software configuration of a device management server 1000.

FIG. 4 is a diagram showing a software configuration of a device 2000.

FIG. 5 is a diagram showing one example of a UI after a device search.

FIG. 6 is a diagram showing one example of a firmware distribution settings screen.

FIG. 7 is a diagram showing one example of a firmware selection screen.

FIG. 8 is a flowchart showing firmware distribution task creation processing.

FIGS. 9A to 9C are flowcharts showing processing for setting the acquisition of latest firmware.

FIGS. 10A and 10B are flowcharts showing firmware update setting processing.

FIG. 11 is a flowchart showing processing to execute a firmware distribution task in the First Embodiment.

FIGS. 12A to 12C are diagrams showing one example of firmware distribution setting screens.

FIG. 13 is a diagram sowing one example of a device selection screen.

FIG. 14 is a diagram showing one example of a firmware selection screen.

FIG. 15 is a diagram showing one example of a schedule setting screen.

FIG. 16 is a diagram showing one example of a schedule confirmation screen.

FIGS. 17A and 17B are diagrams showing one example of distribution confirmation screens.

FIG. 18 is a diagram showing one example of a firmware distribution setting screen after automatic acquisition.

FIG. 19 is a flowchart showing processing to execute a firmware distribution task in a Second Embodiment.

FIG. 20 is a flowchart showing processing to execute a firmware distribution task in a Second Embodiment.

FIG. 21 is a flowchart showing real-time firmware distribution processing in a Third Embodiment.

FIG. 22 is a flowchart showing processing to execute a firmware distribution task in a Fourth Embodiment.

FIG. 23 is a flowchart showing processing to execute a firmware distribution task in a Fourth Embodiment.

FIG. 24 is a diagram showing one example of a device for which distribution is not possible screen.

### DESCRIPTION OF THE EMBODIMENTS

### First Embodiment

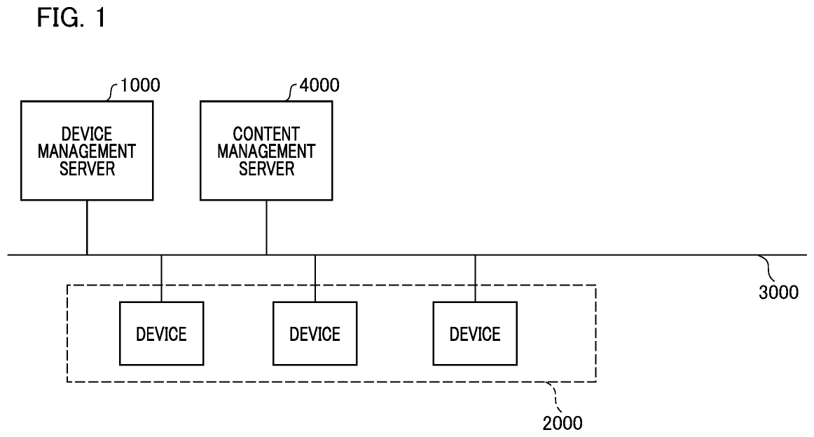

FIG. 1 is diagram showing a configuration of a device management system. The device management system manages a plurality of network devices, which are management targets, via a network, and provides various services to the network devices. Although in the present embodiment, an example is explained for a case in which the network device is an image processing apparatus, this is not limited thereto. The network device may be any type of device with which communication is possible, and may also be, for example, an image forming apparatus, a 3D printer, a laptop computer, a smartphone, a smart electronic, or the like.

In the device management system, a device management server 1000, which is a management apparatus that manages a device, and a plurality of devices 2000 that are managed are communicably connected via a communications line 3000. In addition, the device management server 1000 and a content management server 4000 are communicably connected via the communications line 3000. It is sufficient if the communications line 3000 is configured so as to be able to send and receive data, and the communication protocol does not matter. For example, the communications line 3000 is configured by one of a LAN, a WAN, a cellular network such as LTE, 5G, or the like, a wireless network, a telephone line, a digital private line, or the like, or a combination thereof.

The device 2000 is an image processing apparatus that is able to perform network communications. For example, the device 2000 may be an MFP (multifunction peripheral) having a printing function and a scanning function, or it may also be a single function printer having only a printing function. A device 2000 having a printing function receives print data that has been transmitted via a network, and performs printing on actual paper by using a known printing technology such as an electrophotography technology, an inkjet technology, or the like. A device 2000 having a scanning function reads a paper document via a scanner, and converts this to image data.

The device management server 1000 is a management apparatus that provides a device management service that manages a plurality of devices 2000, which are management targets. Note that although in the present embodiment, an example is explained in which the device management service is provided by the device management server 1000, the present invention is not limited thereto. In addition to one or a plurality of information processing apparatuses, the device management service may also be realized by a virtual machine (a cloud service) that uses resources provided by a data center comprising an information processing apparatus, or a combination thereof. In addition, the device management service that is provided by the device management server 1000 can also be implemented as a web-based application, and can also be used via a web browser on a client terminal such as a PC or the like.

The content management server 4000 provides a contents management service that manages contents such as firmware, expansion applications, or the like for a device. Note that although in the present embodiment, an example is explained in which the contents management service is provided by the content management server 4000, this is not limited thereto. In addition to one or a plurality of information processing apparatuses, the contents management service may also be realized by a virtual machine (cloud service) that uses resources provided by a data center comprising an information processing apparatus, or a combination thereof.

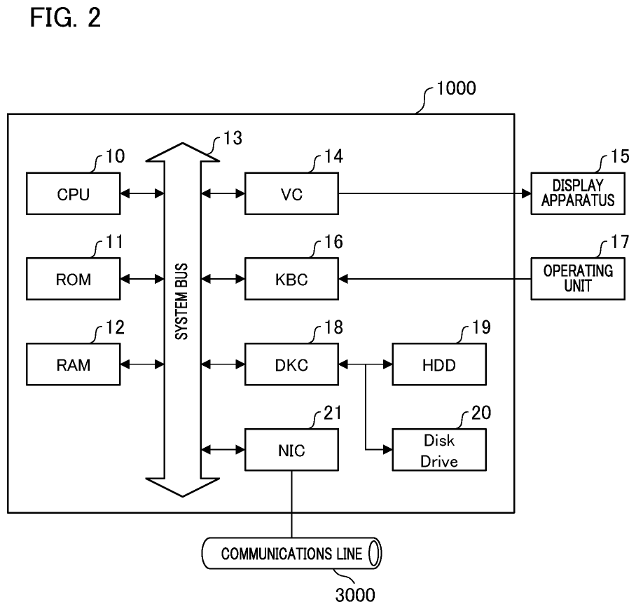

FIG. 2 is a diagram showing a hardware configuration for a device of the device management server 1000. The device management server 1000 has a CPU 10, a ROM 11, a RAM 12, a VC 14, a KBC 16, a DKC 18, an HDD 19, a disk drive 20, and an NIC 21. The CPU 10 controls the entirety of the device management server 1000. The ROM 11 is a data read-only memory, and stores, for example, a basic control program or the like for the device management server 1000. The RAM 12 is a data readable/writable memory, and functions as a work area for the CPU 10. The DKC (disk controller) 18 controls access to a storage apparatus such as the HDD 19 or the like. The HDD (Hard Disk Drive) 19 is one example of a storage apparatus, and stores each type of program, data, and the like. Note that although in the present embodiment, an example is explained in which the information processing apparatus is provided with an HDD 205 to serve as the storage apparatus, this is not limited thereto. For example, another storage apparatus such as an SSD or the like may also be used. The disk drive 20 is able to load a storage medium that is an external media such as a CD-ROM, a DVD, a magnetic tape, an IC memory card, or the like. The CPU 10 uses the RAM 12 as a work area and executes a program that has been stored on the ROM 11 or the HDD 19, and thereby integrally controls each configurational element that is connected to a system bus 13.

A VC (video card) 14 is a video controller, and controls the display to the display apparatus 15. The display apparatus 15 is, for example, an LCD (liquid crystal display). The KBC (keyboard controller) 16 controls input to the device management server 1000. The operating unit 17 is an input apparatus such as a keyboard, a pointing device, or the like. Note that the display apparatus 15 and the operating unit 17 may also be realized by a touch panel in which these are made one. By associating input coordinates and display coordinates on a touch panel, it is possible to configure a GUI such that it is possible for the user to instantly and directly operate a screen that has been displayed on the touch panel. The NIC (network interface board) 21 is a communications controller. The device management server 1000 connects to the communication line 3000 via the NIC 21, and performs data communications with the devices on the communications line 3000.

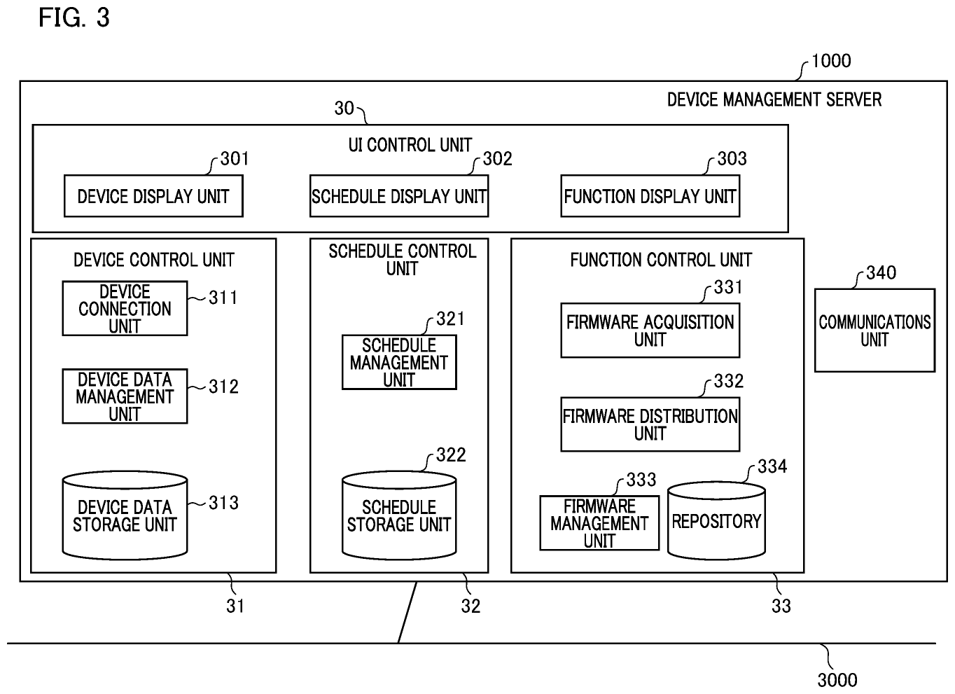

FIG. 3 is a diagram showing a software configuration for the device management server 1000. The device management server 1000 has a UI control unit 30, which is a software module, a device control unit 31, a schedule control unit 32, a function control unit 33, and a communications unit 340. The software module configuration is realized by the CPU 10 reading out and executing a program that is stored on a memory (the ROM 11 or the HDD 19) on the RAM 12.

The UI control unit 30 controls the VC 14, and controls a display of a GUI (graphical user interface) to the display apparatus 15 or the client terminal. A graphical user interface that can be displayed on a client device uses an HTTP (hypertext transfer protocol) and is configured as a web page. Furthermore, the UI control unit 30 receives operations to the UI that has been displayed. That is, the UI control unit 30 controls the display of the UI that is provided by the device management service, and functions as a receiving means that receives commands, selections, settings, and the like from operations of the user to the UI, and is a providing means that provides information using a display.

The UI control unit 30 has a device display unit 301, a schedule display unit 302, and a function display unit 303. The device display unit 301 controls the UI for the device control unit 31, and further receives operations from the user to this UI. The schedule display unit 302 controls the UI for the schedule control unit 32, and further receives operations from the user to this UI. The function display unit 303 controls the UI for the function control unit 33, and further receives operations from the user to this UI.

The device control unit 31 manages devices that are provided by the device management service. The device control unit 31 has a device connection unit 311, a device data management unit 312, and a device data storage unit 313. The device connection unit 311 performs device searches, information collection from devices, and setting commands to devices. As on example of a function of the device connection unit 311, there is a device search function for the device 2000 using SNMP, IP broadcast, SLP/Multicast, or the like. At that time, the device connection unit 311 performs searches for devices 2000 at arbitrary timings. In addition, the device connection unit 311 has a function for acquiring/changing device information such as MIB (management information base) security policy information via the communications line 3000. In addition, the device connection unit 311 acquires device information such as the device name, the product name, the IP address, and the like to serve as the device search results, and stores these to the device data storage unit 313. The device data management unit 312 manages data from the device data storage unit 313. The device data storage unit 313 stores device information and the like. The device data storage unit 313 is a data recording medium such as a database that operates on the HDD 19 or the like.

The schedule control unit 32 manages the schedule for services that are provided by the device management service. The schedule control unit 32 has a schedule management unit 321, and a schedule storage unit 322. The schedule management unit 321 cooperates with each function of the function control unit 33, and creates and manages schedules that have been input by the schedule display unit 302 and stores these on the schedule storage unit 322. The schedule storage unit 322 stores schedules that have been created by the schedule management unit 321. The schedule storage unit 322 is a data recording medium such as a database that functions on the HDD 19, or the like.

The function control unit 33 performs control relating to the device firmware. The function control unit 33 has a firmware acquisition unit 331, a firmware distribution unit 332, a firmware management unit 333, and a repository 334. The firmware acquisition unit 331 acquires device firmware from the content management server 4000. The firmware acquisition unit 331 functions as an acquisition means that acquires firmware that has been selected by the user, and automatically acquires the latest firmware. Note that in the present embodiment, although an example has been explained in which the firmware acquisition unit 331 acquires the firmware, this is not limited thereto. For example, the firmware acquisition unit 331 may also acquire image files comprising the firmware that is used in updates to the device from the content management server 4000. In this context, the image files are articles in which data groups comprising the firmware that is necessary for an update are made into files per structure.

The firmware distribution unit 332 controls the distribution of firmware to the device. The firmware distribution unit 332 functions as an update means that distributes firmware to the device and updates it. The firmware management unit 333 manages storage to and deletion from the repository 334, which is the designated storage destination for firmware. The firmware management unit 333 functions as a storage means and a deleting means for firmware. The repository 334 is a storage destination that stores firmware. The repository 334 is, for example, a data recording medium that operates on the HDD 19. The communications unit 340 controls communications with an external device on a network such as the device 2000, the content management server 4000, or the like.

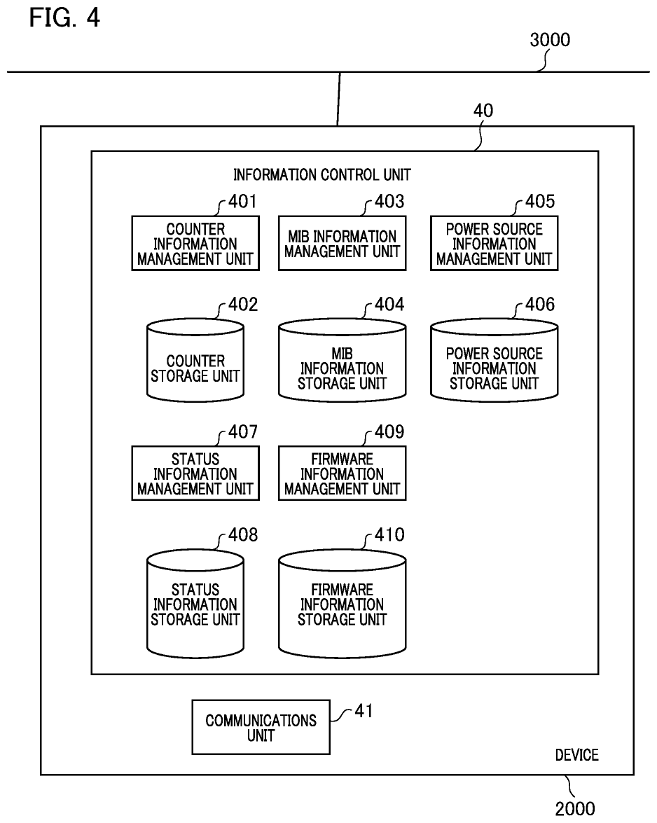

FIG. 4 is a diagram showing a software configuration of the device 2000. The configuration of the software module is realized by the CPU of the device 2000 executing a program that is stored on a memory. The device 2000 has an information control unit 40 for managing a plurality of information groups that dynamically change, as well as a communications unit 41 as software modules. The information control unit 40 has a counter information management unit 401, an MIB information management unit 403, a power source information management unit 405, a status information management unit 407, and a firmware information management unit 409. In addition, it has a counter storage unit 402, an MIB information storage unit 404, a power source information storage unit 406, a status information storage unit 408, and a firmware information storage unit 410 that serve as storage regions for data corresponding to each management unit.

The counter information management unit 401 manages the number of printed pages or the like, and stores this on the counter storage unit 402. The MIB information management unit 403 manages MIB information, which is the device information described above, and stores this on the MIB information storage unit 404. The power source information management unit 405 manages power source off information and reboot information and stores this on the power source information storage unit 406. The status information management unit 407 manages status information for a device such as online, offline, error, or the like, and stores this on the status information storage unit 408.

The firmware information management unit 409 manages information such as the configuration, the version, or the like of the firmware for the device 2000, and stores this on the firmware information storage unit 410. In addition, the firmware information management unit 409 also manages firmware that has been distributed for a version upgrade, and information, and stores this on the firmware information storage unit 410. The data that is managed by each management unit is transmitted to the device management server 1000 using SNMP or another protocol in accordance with a request from the device management server 1000. The communications unit 41 controls communications between external devices on a network with the device management server 1000 or the like.

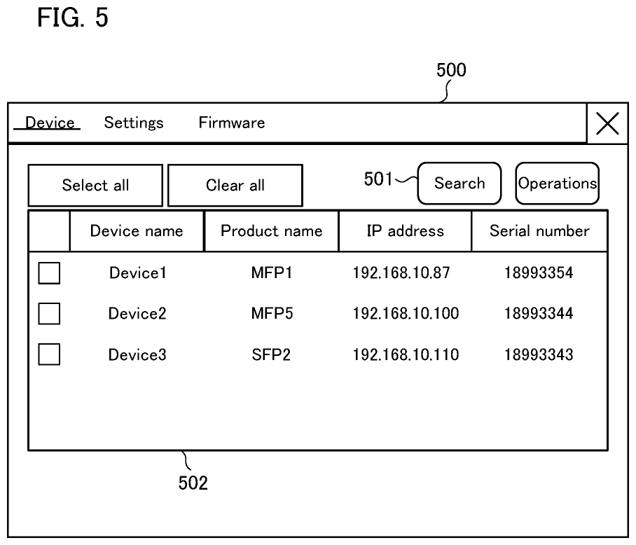

The flow for the device searches and the acquisition in advance of firmware will be explained using FIGS. 5 to 7. FIGS. 5 to 7 are UIs that are provided by the UI control unit 30 of the device management server 1000. When a device is managed in the device management server 1000, first, a search for the device is performed. The search for the device may be performed for each user command, or a schedule may be set, and this may be periodically performed. In addition, in a case in which a firmware update is performed for a device that has been searched for, the firmware that will be distributed to the device is acquired from the repository 334 in advance.

First, the search for a device will be explained. The device management server 1000 searches for a device that will become a management target from on a network. As an algorithm for searching for a device, there is, for example, SNMP, or the like. However, the format thereof does not matter. FIG. 5 is a diagram showing one example of a UI after a device search. A search screen 500 displays a search button 501. Upon the search button 501 being pressed down, a search setting screen, which is not illustrated, is displayed. The user performs the search settings on the search setting screen, and commands a device search. On the search setting screen, it is possible to set, for example, the range and searching method for the network on which a device will be searched for, IP addresses that should be made outside of the search range, and the like. The device management server 1000 performs a device search in accordance with the search settings that have been indicated by the user.

After the device search, a device list 502 is displayed on the search screen 500. The device information for the devices that have been searched for are displayed on the device list 502. The device information includes, for example, a device name, a product name, an IP address, a serial number, and the like. The device information that is displayed on the device list 502 includes device information for devices that have been acquired during this search, and device information that was acquired by searches up until the previous search that is stored on the device storage unit 313.

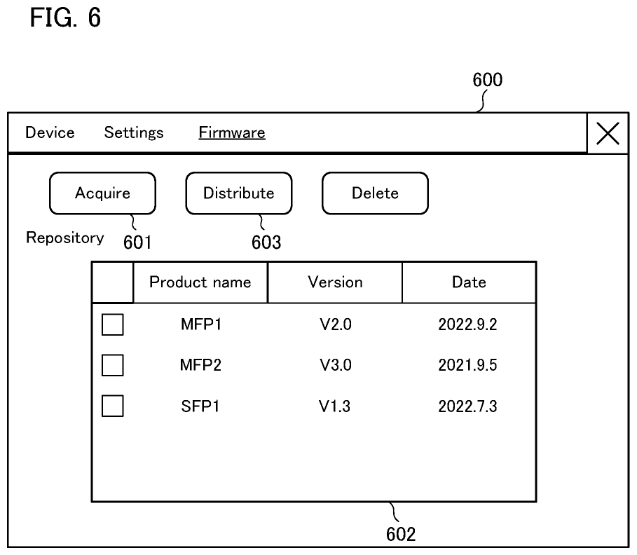

FIG. 6 is a diagram showing one example of a firmware distribution setting screen. In order to distribute firmware to a device, first, it is necessary to acquire the firmware to be distributed from the repository of the device management server 1000. An acquisition button 601 for acquiring the firmware from the repository 334 is displayed on the distribution setting screen 600. Upon the acquisition button 601 being pressed down, the device management server 1000 connects to the content management server 4000 and acquires information for the firmware that can be acquired.

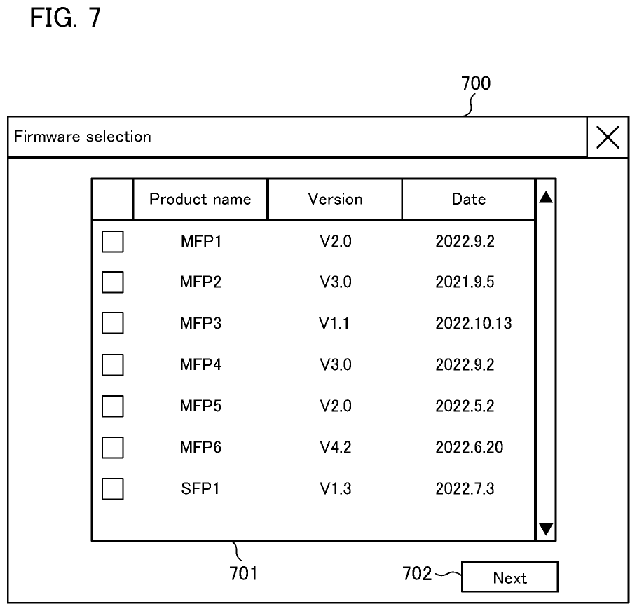

FIG. 7 is diagram showing one example of a firmware selection screen. A firmware list 701 that shows a list of the firmware that can be acquired from the content management server 4000 is displayed so as to be selectable on the firmware selection screen 700. For example, the device information for the device that will be the distribution target for the firmware, the firmware version, and the start date for the distribution of the firmware are displayed on the firmware list 701 to serve as firmware information. For example, a product name is displayed as the device information for a device. By the user selecting the necessary firmware and pressing down a next button 702, the device management server 1000 acquires the selected firmware and stores it on the repository 334, which is the designated storage destination.

The explanation will now return to FIG. 6. A distribution firmware list 602 that shows a list of the firmware that can be distributed to the device is displayed on the distribution setting screen 600. For example, a product name that serves as the device information for the device that will be the distribution target for the firmware, the firmware version, and the distribution start date for the firmware are displayed on the distribution firmware list 602 to serve as firmware information. The firmware that is displayed on the distribution firmware list 602 is the firmware that is stored in the repository 334. In the example that is shown in FIG. 6, three firmware are stored on the repository 334, the firmware for which the version is 2.0 that is being distributed to the device for which the product name is MFP1, the firmware for which the version is V3.0 that is being distributed to the device for which the product name is MFP2, and the like. The user selects the firmware to be distributed to the device from the distribution firmware list 602, and presses down a distribute button 603.

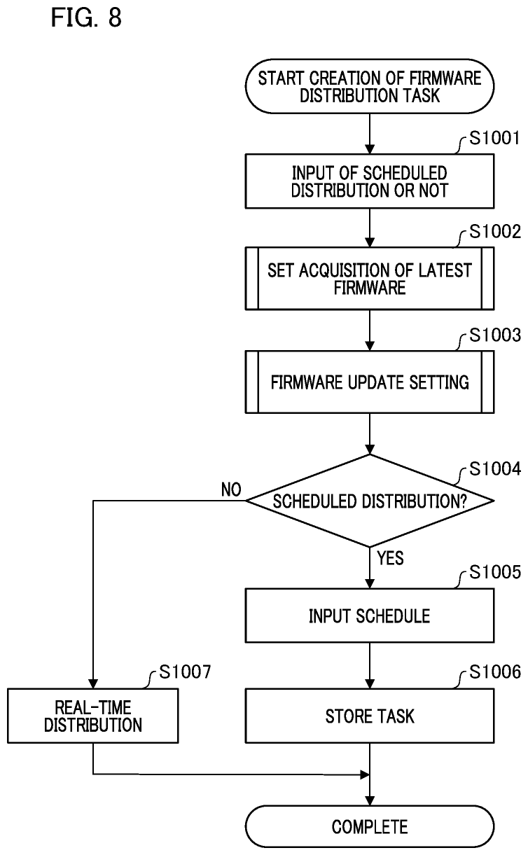

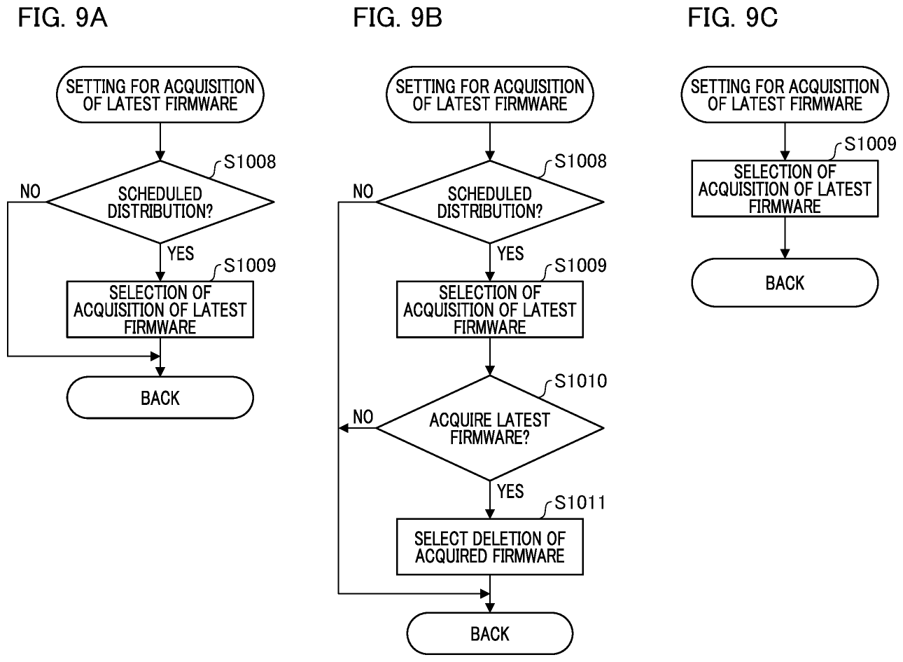

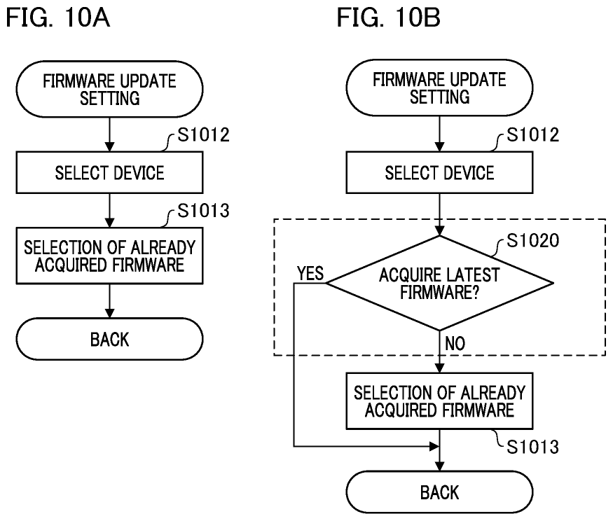

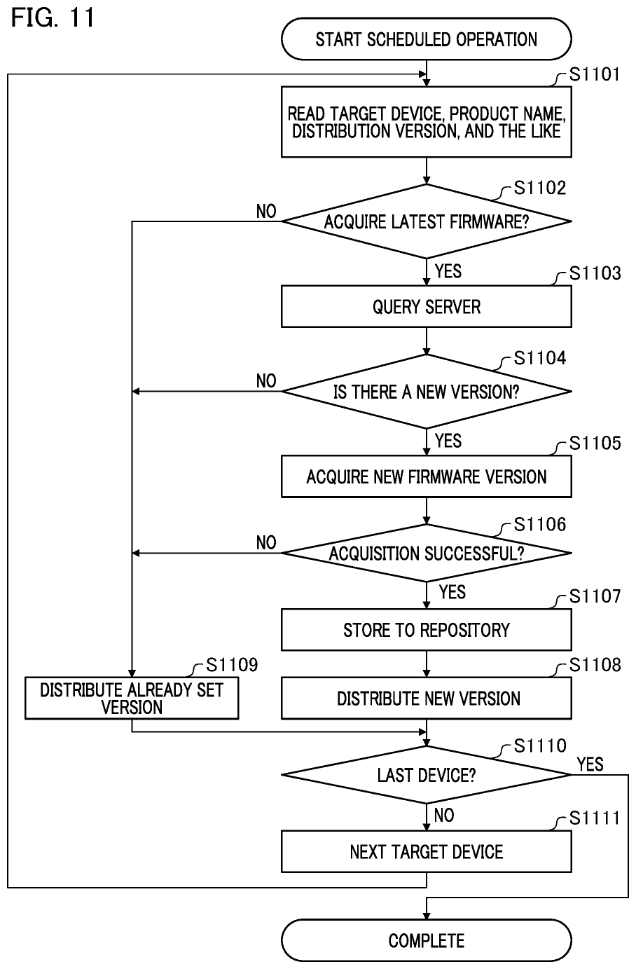

Next, the processing for the distribution of firmware will be explained using the flowcharts from FIG. 8 to FIG. 11. FIG. 8 is a flowchart showing firmware distribution task creation processing. FIG. 9A is a flowchart showing setting processing for acquiring the latest firmware for S1002. FIG. 10A is a flowchart showing firmware update setting processing for S1003. FIG. 11 is a flowchart showing processing to execute a firmware distribution task.

First, the processing for creating a firmware distribution task will be explained. The processing for creating a firmware distribution task is begun by the detection of the distribute button 603 of the distribution setting screen 600 that is shown in FIG. 6 being pressed down. Note that the firmware distribution task creation processing is realized by the CPU 10 of the device management server 1000 executing a program that has been stored on a memory (the ROM 11 or the HDD 19).

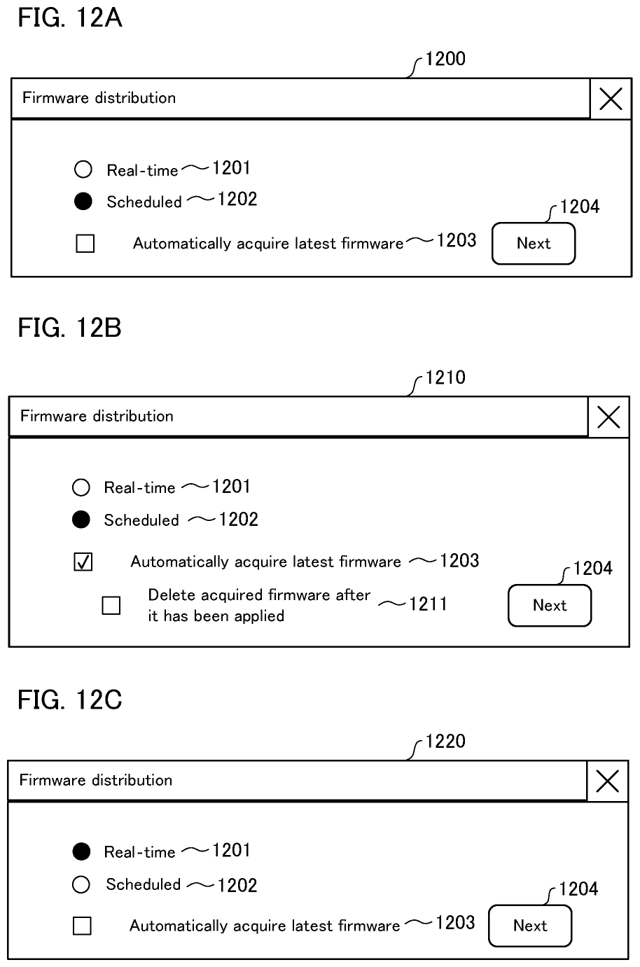

During S1001, upon detecting that the distribute button 603 has been pressed down, the function display unit 303 performs the display of a UI for performing a distribution setting as to whether or not to perform scheduled distribution of firmware. The distribution setting screen, which is a UI on which the distribution setting is performed, will be explained using FIG. 12A. FIG. 12A is a diagram showing one example of a firmware distribution setting screen. Real-time distribution and scheduled distribution are displayed so as to be selectable on the distribution setting screen that is displayed during S1001. In a case in which scheduled distribution will be performed, the user selects schedule 1202, and in a case in which real-time distribution will be performed, the user selects real-time 1201. During scheduled distribution, by creating a task in which the date and time at which the firmware will be distributed has been indicated, it is possible to execute firmware updates at a timing during which the device is not being used, such as outside of business hours, or the like.

During S1002, the function display unit 303 performs processing to set whether or not to perform the acquisition of the latest firmware. The latest firmware is the latest version of the firmware. In the present embodiment, in a case of real-time distribution, automatic acquisition of the latest firmware is not performed, and in a case of scheduled distribution, the user is made to select whether or not to automatically acquire the latest firmware. The details of the setting processing for the acquisition of the latest firmware for S1002 in the First Embodiment will be explained using FIG. 9A. FIG. 9A is a flowchart showing the setting processing for the acquisition of the latest firmware in the First Embodiment. Note that the present processing is realized by the CPU 10 of the device management server 1000 executing a program that has been stored on a memory (the Rom 11 or the HDD 19)

During S1008, the firmware distribution unit 332 determines whether or not the distribution setting that has been selected during S1001 is scheduled distribution. In a case of scheduled distribution, the processing for S1009 is performed. In contrast, in a case that this is not scheduled distribution, the present processing is completed, and the flow returns to the processing of FIG. 8. During S1009, the function display unit 303 displays a setting item for whether or not to execute the acquisition of the latest firmware on the distribution setting screen 1200 so as to be selectable, and receives the selection of the user.

FIG. 12A is a diagram showing one example of a distribution setting screen that is displayed during S1009. Upon schedule 802 being selected on the distribution setting screen 1200, the function display unit 303 displays an automatic acquisition setting item 1203 to as to be selectable. The automatic acquisition setting item 1203 is a check box on which whether or not to automatically acquire and distribute the latest firmware when distributing the firmware to the device is selected. When performing scheduled distribution, in a case in which the automatic acquisition of the latest firmware will be executed at that time, the user adds a check to the check box. By performing the automatic acquisition of the latest firmware, it is possible to perform an update with the latest firmware at the time of the scheduled distribution. In contrast, in a case in which real-time 802, which performs real-time distribution, was selected during S1001, the check box for the automatic acquisition setting item 1203 is displayed on the distribution setting screen 1200 in a state in which it cannot be selected, for example by it being blacked out.

The explanation will now return to FIG. 8. Upon a next button 804 being pressed down on the distribution setting screen 1200, the processing for S1003 is performed. During S1003, the function display unit 303 performs firmware update settings based on the selection of the user. The details of the firmware update setting processing for S1003 in the First Embodiment will be explained using FIG. 10A. FIG. 10A is a flowchart showing the firmware update setting processing in the First Embodiment. Note that the present processing is realized by the CPU 10 of the device management server 1000 executing a program that has been stored on a memory (the ROM 11 or the HDD 19).

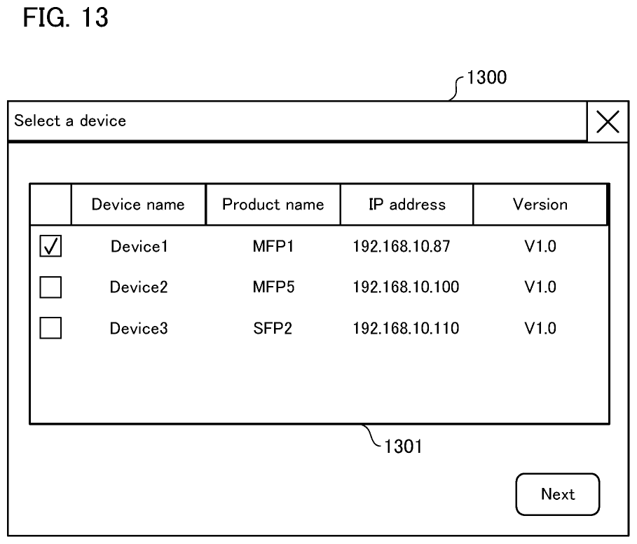

During S1012, the function display unit 303 receives the selection of the device for which the firmware update will be performed. Specifically, the function display unit 303 first displays a list of devices for which a search has already been completed that have been acquired from the device data storage unit 313, and performs the display of a UI that prompts the selection of which device to perform the firmware update for. In addition, the function display device 303 receives the selection of the device from the user. Note that it is possible for the user to select a plurality of devices. One example of a screen that is displayed during S1012 is shown in FIG. 13.

FIG. 13 is a diagram showing one example of a device selection screen. A searched device list 1301 is displayed on the device selection screen 1300. The searched device list 1301 displays the device name for a device, the product name, the IP address, the version information for the firmware, and the like. In the example that is shown in FIG. 13, the device for which the device name is “Device1” and for which the product name is the device “MFP1” has been selected as the device for which the firmware update will be performed.

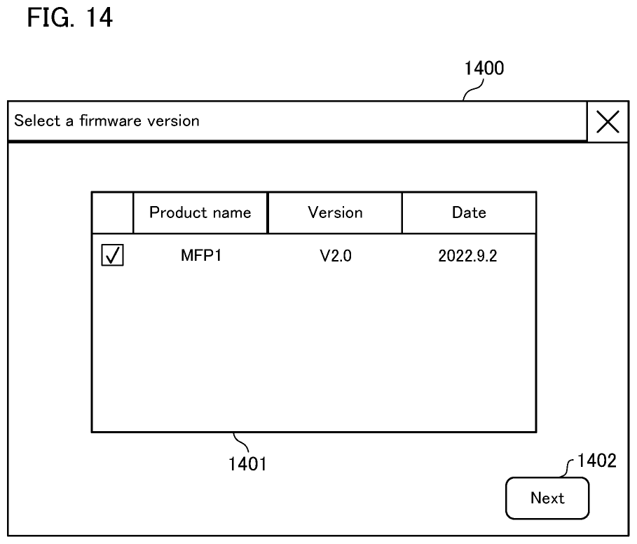

During S1013, the function display unit 303 displays the firmware that can be applied to the device that was selected during S1012. Specifically, the function display unit 303 acquires the information for the firmware that can be applied to the device that was selected during S1012 that is stored on the repository 334 via the firmware management unit 333 and displays this as a list, and performs the display of a UI that prompts the selection of the firmware to be applied. In addition, the function display unit 303 receives the selection of the firmware from the user. Note that it is possible for the user to select a plurality of firmware. One example of a screen that is displayed during S1013 is shown in FIG. 14.

FIG. 14 is a diagram showing one example of a firmware selection screen. A firmware list 1401 that shows firmware information that has already been acquired from the repository 334 and that can be applied to the device that was selected during S1012 is displayed on the firmware selection screen 1400 so as to be selectable. The firmware list 1401 displays, for example, the product name for the device, the version for the firmware, and the date on which this version began being distributed. The user selects a version of the firmware to be distributed to the device and presses down a next button 1402 on the firmware selection screen 1400.

The explanation will now return to FIG. 8. Upon detecting that the next button 1402 has been pressed down on the firmware selection screen 1400, the device management server 1000 performs the processing for S1004. During S1004, the firmware distribution unit 332 determines whether or not the distribution setting that was set during S1001 is scheduled distribution. In a case in which this is scheduled distribution, the processing for S1005 and S1006 is performed. In contrast, in a case in which this is not scheduled distribution, the processing for S1007 is performed.

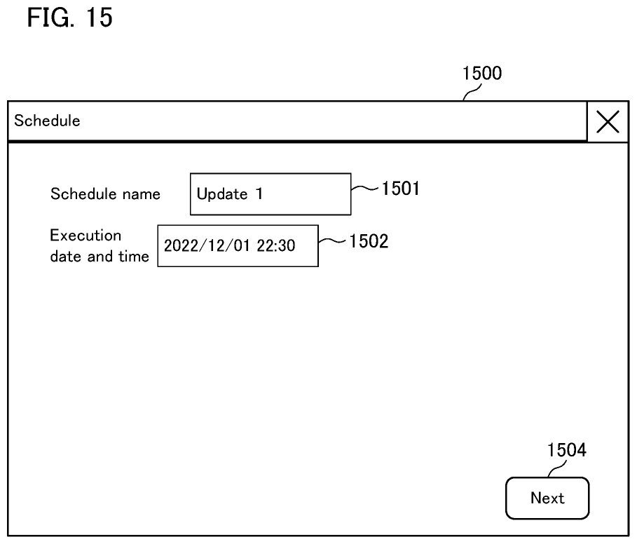

First, the processing for a case in which scheduled distribution has been selected will be explained. During S1005, the function display unit 303 receives the setting of the date and time at which the firmware will be distributed, Specifically, the function display unit 303 performs a UI display that prompts the input of the date and time for the scheduled distribution, and receives the input of the distribution date and time from the user. One example of a screen that is displayed during S1005 is shown in FIG. 15. FIG. 15 is a diagram showing one example of a schedule setting screen. The user specifies a schedule name 1501 and an execution date and time 1502 on the schedule setting screen 1500. In the example that is shown in FIG. 15, “update 1” has been input into the schedule name 1501, and “2022/12/01 22:30” has been input into the execution date and time 1502.

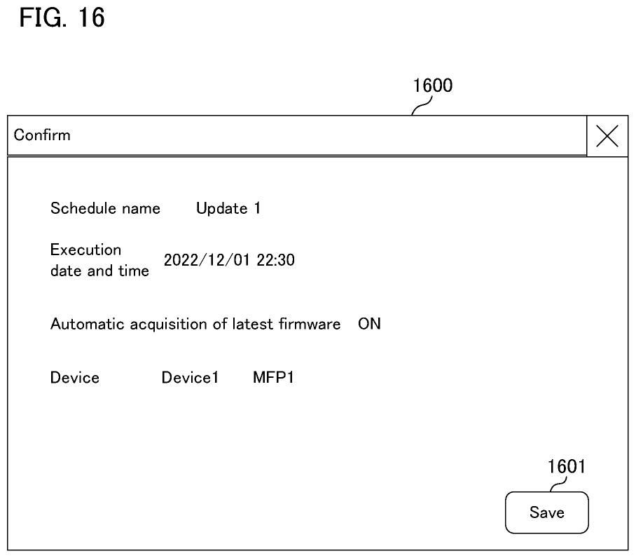

Upon the user pressing down a next button 1504 on the schedule setting screen 1500, the function display unit 303 displays a schedule confirmation screen. FIG. 16 is a diagram showing one example of a schedule confirmation screen. The schedule name, and execution date and time that were set on the schedule setting screen 1500 (during S1005), the device that will become the target for the firmware update, and whether the automatic acquisition setting for the latest firmware is on or off are displayed on the schedule conformation screen 1600. The schedule name and the execution date and time are the contents that were set on the schedule setting screen 1500 (during S1005). The device is the device that was selected on the device selection screen 1300 (S1012). Whether the automatic acquisition setting for the latest firmware is on or off is the content that was set on the distribution setting screen 1200 (during S1009). In the example that is shown in FIG. 16, the schedule name is “update 1”, the execution date and time is “2022/12/01 22:30”, automatic acquisition of the latest firmware is “on”, and the device is the “device 1”. Upon a save button 1601 on the schedule confirmation screen 1600 being pressed down, the device management server 1000 performs the processing for S1006.

During S1006, the schedule management unit 321 stores the firmware distribution task. The schedule management unit 321 creates a firmware distribution task that includes the information for the device that is the distribution target and the firmware that were selected during S1003, the distribution date and time that was set during S1005, and the information for whether or not to acquire the latest firmware that was set during S1009. Then, the schedule management unit 321 stores the firmware distribution task that was created on the schedule storage unit 322.

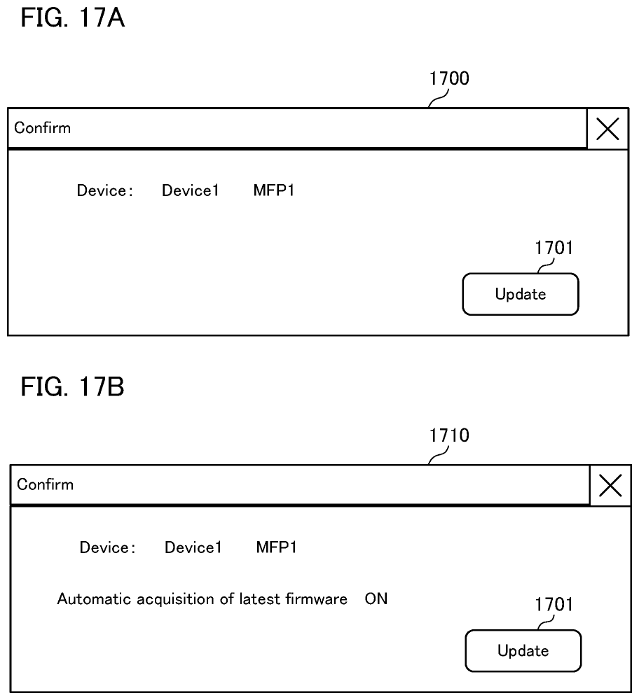

Next, the processing for a case in which real-time distribution has been selected will be explained. During S1007, the firmware distribution unit 332 performs processing for the distribution of the firmware that was selected during S1013 in real-time to the device that was selected during S1012. Specifically, first, the function display unit 303 displays a real-time distribution confirmation screen. FIG. 17A is a diagram showing one example of a real-time distribution confirmation screen. The device that is the update target that was set during S1012 is displayed on a real-time distribution confirmation screen 1700. Upon the user pressing down an update button 1701 of the real-time distribution confirmation screen 1700, the firmware distribution unit 332 distributes the firmware that was selected during S1013 in real-time to the device that is shown on the real-time distribution confirmation screen 1700.

According to the above processing, in a case in which real-time distribution has been selected, the device management server 1000 receives the selection of the device that is the distribution target and the firmware, and distributes the selected firmware to the selected device in real-time. In contrast, in a case in which scheduled distribution has been selected, the device management server 1000 receives the selection of the device that is the distribution target and the firmware, the setting of whether or not to automatically acquire the latest firmware at the timing of the distribution, and the setting of the schedule for distribution, and stores the task. By storing the setting for automatically acquiring the latest firmware at the timing of the update for the firmware for the device during scheduled distribution in the task, it is possible to automatically acquire the latest firmware at the timing at which the firmware is updated by executing the task.

In the device management server 1000, when it becomes the date and time that were set in the task, the scheduled task is begun by the schedule control unit 32. A firmware distribution task is also one type of scheduled task. FIG. 11 is a flowchart showing the processing for executing a distribution task for the firmware in the First Embodiment. The execution processing for the firmware distribution task is realized by the CPU 10 of the device management server 1000 executing a program that has been stored on a memory (the ROM 11 or the HDD 19).

During S1101, the firmware distribution unit 332 acquires the information such as the target device for which firmware distribution will be performed, the product name, the distribution version, and whether or not it is necessary to automatically acquire the latest firmware, and the like from the firmware distribution task that is stored in the schedule storage unit 322. In the examples that are shown in FIG. 14 and FIG. 16, the target device “Device1”, the product name “MFP1”, and the distribution version “V2.0” are read. In addition, the firmware distribution unit 332 also acquires the information for if the acquisition of the latest firmware will be performed, which was selected during S1009, from the task. Note that in a case in which there is a plurality of devices that are indicated as the update target in the firmware distribution task, the present processing is executed for each device one device at a time.

During S1102, the firmware distribution unit 332 determines whether or not to perform the acquisition of the latest firmware based on the information that was acquired during S1101. In a case in which the acquisition of the lasted firmware will be acquired, the processing for S1103 is performed. In contrast, in a case in which the acquisition of the latest firmware will not be acquired, the processing for S1109 is performed.

In a case in which the acquisition of the latest firmware will be performed, during S1103, the firmware distribution unit 332 queries the content management server 4000 about the latest firmware via the firmware acquisition unit 331. The firmware distribution unit 332 performs a query about whether or not there is a version of the firmware that is newer than the version of the firmware that is recorded in the task based on the product name and the version that have been acquired from the firmware distribution task. For example, based on the device name “MFP1” and the version “V2.0” it will confirm if there is a version that is newer than the version “2.0” for the firmware corresponding to the product with the product name “MFP1”.

During S1104, the firmware distribution unit 332 determines whether or not there is a newer version of the firmware. The firmware distribution unit 332 acquires the results of the query from S1103 from the content management server 4000, and determines whether or not there is new version of the firmware based on the results of the query. In a case in which it has been determined that there is a new version of the firmware, the processing for S1105 is performed. In contrast, in a case in which it has been determined that there is not a new version of the firmware, the processing for S1109 is performed.

During S1105, the firmware acquisition unit 331 performs the acquisition of the new version of the firmware from the content management server 4000. For example, in a case in which a version “V3.0” that is newer than the version “V2.0” has been released for the firmware corresponding to the product with the product name “MFP1”, the firmware acquisition unit 331 acquires the firmware for the version “V3.0”.

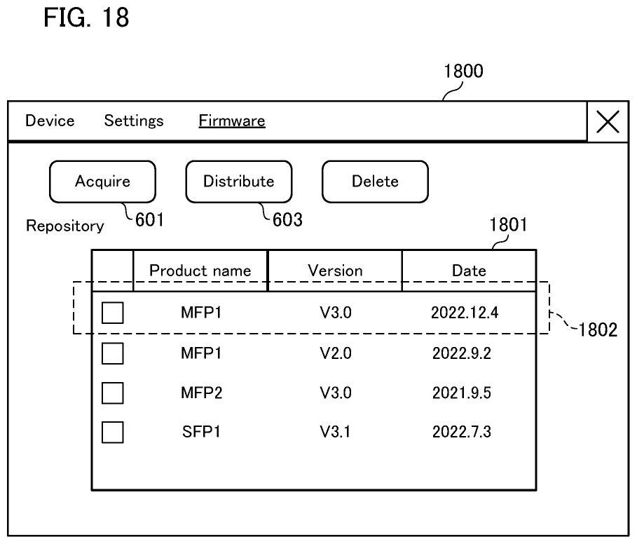

During S1106, the firmware acquisition unit 331 determines whether or not the acquisition of the firmware during S1105 was a success. In a case in which it has been determined that the acquisition of the firmware was successful, the processing for S1107 is performed. In contrast, in a case in which it has been determined that the acquisition of the firmware was not successful, the processing for S1109 is performed. During S1107, the firmware acquisition unit 331 stores the new version of the firmware that was acquired during S1105 to the repository 334, which is the designated storage destination for firmware. For example, in a case in which the version “V3.0” for the firmware has been acquired during S1105, the version “V3.0” for the firmware is stored on the repository 334 during S1107. FIG. 18 is a diagram showing one example of a firmware distribution setting screen post automatic acquisition. The latest firmware 1802 that was acquired by automatic acquisition and was stored on the repository 334 is displayed in a distribution firmware list 1801 of the firmware distribution setting screen 1800 after automatic acquisition. In the example that is shown in FIG. 18, it is understood that the firmware that is distributed to the device with the device name MFP1, for which the version is V3.0, is stored on the repository 334.

During S1108, the firmware distribution unit 332 performs distribution of the firmware to the device using the new firmware version that was acquired during S1105 and stored on the repository 334 during S1107. During the distribution of the firmware to the device, the firmware distribution unit 332 transmits the firmware to which the device will be updated and also performs a command to update this to the firmware that is transmitted. For example, in a case in which the firmware for the version “V3.0” has been acquired during S1105, the firmware for the version “V3.0” is stored on the repository 334 during S1107, and during S1108 this is distributed to the device and an update command is performed.

During S1109, the firmware distribution unit 332 performs the distribution of the firmware to the device using the firmware version that had already been set at the time of the task creation. During S1110, the firmware distribution unit 332 determines if the device that has been selected as the current update target is the final device that is indicated as an update target in the firmware distribution task. In a case in which it has been determined that this is the final device, the present processing is completed. In contrast, in a case in which it has been determined that this is not the final device, the processing for S1111 is performed. During S1111, the firmware distribution unit 332 indicates the next device that has been selected to serve as the update target in the firmware distribution task as the target for the firmware distribution processing, and the processing returns to S1101.

During scheduled distribution based on a task, in a case in which it has been determined during S1102 that the acquisition of the latest firmware is “off”, the update command is performed using “V2.0”, which is the version that has already been set during S1109. In addition, even if the acquisition of the latest firmware is “on”, in a case in which it has been determined during S1104 that there is not a new version, or in a case in which it has been determined that the acquisition during S1106 failed, the update command is performed using “V2.0”, which is the version that has already been set during S1109. In contrast, in a case in which the acquisition of latest firmware is “on”, and the acquisition of the latest version was successful, the update command is performed using “V3.0”, which is the latest version during S1108. In this manner, in a case in which a setting has been received so as to automatically acquire the latest firmware during scheduled distribution based on a task, the latest firmware that should be distributed to the device is automatically acquired, and stored on the repository 334 at the timing of the update in accordance with the schedule.

In the present embodiment, as is shown in FIG. 8 and FIG. 9, at the time of the selection of scheduled distribution of the firmware, the option for the automatic acquisition of the latest firmware is provided. In addition, in a case in which the automatic acquisition of the latest firmware has been set, it is confirmed whether or not there is a newer version than the firmware that is already stored on the repository 334 at the time of the execution of the scheduled task using the processing that is shown in FIG. 11. In a case in which there is a new version of the firmware, the latest firmware is automatically acquired then stored on the repository 334, and the latest firmware is distributed to the device. According to the above processing, it is made possible to update the device using the latest firmware.

### Second Embodiment

In the First Embodiment, it was made such that the firmware that was automatically acquired was stored in the repository as is. In the present embodiment, it is made possible to select whether to store the firmware that has been automatically acquired in the repository or to delete this after it has been applied to the device. Note that in the present embodiment, only differences from the First Embodiment will be explained.

First, the processing for creating a scheduled distribution task will be explained. Although during the task creation processing of S1002 in the First Embodiment that is shown in FIG. 8, the processing that is shown in FIG. 9 A was executed, in the Second Embodiment, during S1102, the processing that is shown in FIG. 9 B will be executed. FIG. 9 B is a flowchart showing the latest firmware acquisition setting processing in the Second Embodiment. Note that the processing that is shown in FIG. 9B is realized by the CPU 10 of the device management server 1000 executing a program that has been stored on the memory (the ROM 11 or the HDD 19).

In a case in which the user has selected scheduled distribution, during S1009, the function display unit 303 displays the setting item for whether or not to execute the automatic acquisition of the latest firmware on the distribution setting screen so as to be selectable and receives the selection of the user. In the Second Embodiment, following the processing for S1009, the processing for S1010 is performed. During S1010, it is determined whether or not the user has selected the acquisition of the latest firmware during S1009. In a case in which it has been determined that the acquisition of the latest firmware has been selected, the processing for S1011 is performed. In contrast, in a case in which it has been determined that the acquisition of the latest firmware has not been selected, the present processing is completed, and the flow returns to the processing of FIG. 8.

During S1011, the function display unit 303 displays on the firmware distribution setting screen the selection for whether or not to delete the acquired firmware from the repository 334 after it has been applied to the device, and receives the selection of the user. FIG. 12B is a diagram showing one example of the distribution setting screen in the Second Embodiment. If scheduled distribution is selected and the automatic acquisition of the latest firmware is further selected on the distribution setting screen 1210, the function display unit 303 displays a setting item 1211 for the deletion of firmware. The setting item 1211 for the deletion of firmware is a check box in which whether or not to delete the latest firmware that has been distributed from the repository after the latest firmware, which has been automatically acquired, has been distributed to the device, is selected. In a case in which the latest firmware that has been automatically acquired should be deleted after distribution, the user checks off the check box. The setting for whether or not to delete the latest firmware that has been automatically acquired is set in the task along with the other selected contents, and stored in the schedule storage unit 322 when the task is created and stored during S1006.

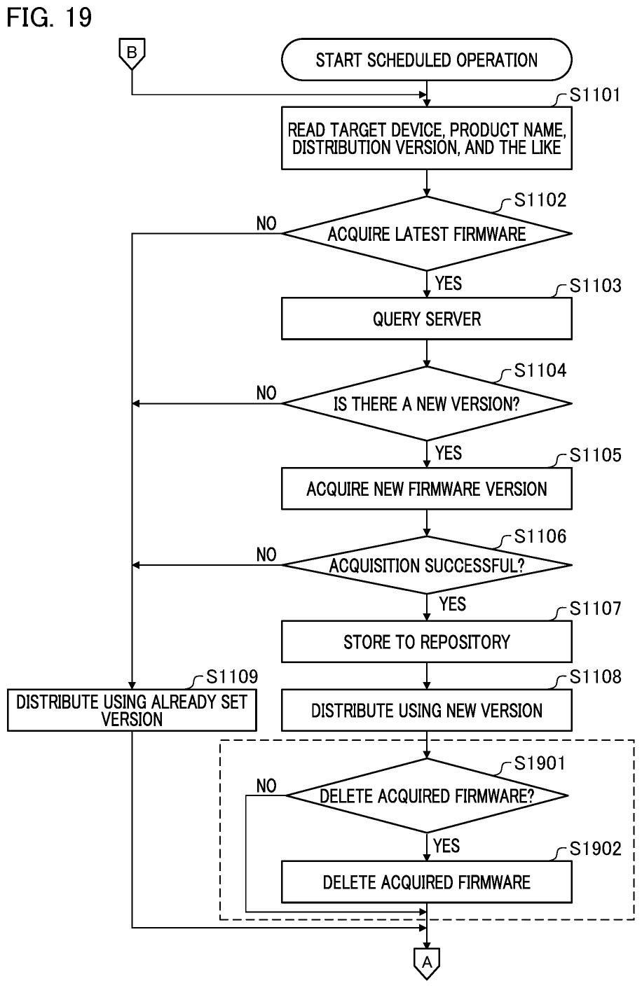

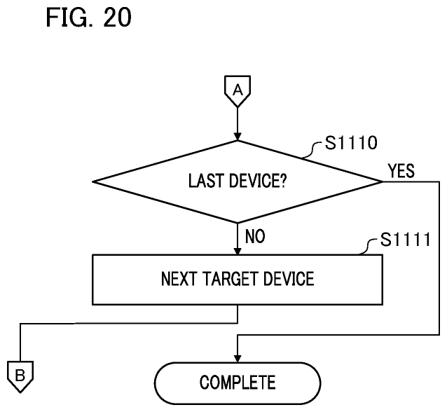

Next, the processing for executing the scheduled distribution task will be explained. FIG. 19 and FIG. 20 are flowcharts showing the processing for executing the task for firmware distribution in the Second Embodiment. The processing for executing the firmware distribution task is realized by the CPU 10 of the device management server 1000 executing a program that has been stored on a memory (the ROM 11 or the HDD 19).

During S1101, the firmware distribution unit 332 acquires information such as the target device for the firmware distribution, the product name, the distribution version, whether or not it is necessary to automatically acquire the latest firmware, and the like from the firmware distribution task that is stored in the schedule storage unit 322. Furthermore, in the present embodiment, the firmware distribution unit 332 also acquires the information for whether or not to delete the latest firmware that has been automatically acquired after this firmware has been distributed from the firmware distribution task that is stored in the schedule storage unit 322.

In a case in which a setting has been made such that the latest firmware is automatically acquired during the scheduled distribution, and the latest firmware exists, the device management server 1000 acquires the latest firmware during S1105, and stores this on the repository 334 during S1107. In addition, in the present embodiment, the device management server 1000 performs the processing for S1901 after the latest firmware has been distributed to the device during S1108.

During S1901, the firmware management unit 333 determines whether or not to perform the deletion of the firmware that has been automatically acquired based on the information that was acquired during S1101. In a case in which it has been determined that the deletion of the firmware will be performed, the processing for S1902 is performed. In contrast, in a case in which it has been determined that the deletion of the firmware will not be performed, the processing for S1110 is performed. During S1902, the firmware management unit 333 performs the deletion of the latest version of the firmware that was acquired during S1105 and stored during S1107 from the repository 334. For example, in a case of the latest firmware 1602 that is shown in FIG. 18, for which the version is V3.0, and which is the firmware has been automatically acquired and then applied to the device, during S1902, the firmware management unit 333 deletes the latest firmware 1602 from the repository 334. After deletion, the firmware that is stored in the repository 334 is the firmware from before the automatic acquisition, that is, it is the firmware that is shown in the distribution firmware list 602 of FIG. 6. Upon the completion of the deletion of the firmware during S1902, the processing for S1110 is performed.

In this manner, in the present embodiment, it is made possible to select whether to store the latest firmware that has been automatically acquired in the repository 334, or to delete this after it has been applied to the device. In addition, in a case in which the selection of deletion has been received, it is made possible to delete the latest firmware that has been automatically acquired from the repository 334 after it has been applied to the device.

### Third Embodiment

It can be thought that there will be cases in which, during the time from when the firmware is acquired in the repository 334 until the execution of the processing to apply this firmware to a device, time will have passed and a newer version of the firmware than this firmware will exist. In the First Embodiment and the Second Embodiment, it was made possible to automatically acquire the latest firmware only in a case of scheduled distribution. However, in the present embodiment, an automatic acquisition option will also be provided in a case in which scheduled distribution is not selected, and it will be made possible to acquire the latest firmware. Note that in the present embodiment, only the differences with the First Embodiment will be explained.

First, the task creation processing for firmware distribution in the Third Embodiment will be explained. During S1001, upon detecting the pressing down of the distribute button 603, the function display unit 303 performs the display of a UI for performing the distribution setting for whether or not to perform scheduled distribution of the firmware, and real-time distribution and scheduled distribution are displayed so as to selectable. During S1002, the function display unit 303 receives the setting for the automatic acquisition of the latest firmware. The details of the processing for S1002 during the present embodiment will be explained using FIG. 9 C. FIG. 9 C is a flowchart showing the acquisition setting processing for the latest firmware in the Third Embodiment. In the First Embodiment and the Second Embodiment, the selection of whether or not to automatically acquire the latest firmware was received only in cases in which scheduled distribution had been selected. However, in the present embodiment, selection of automatic acquisition is also received in cases in which real-time distribution has been selected. In the present embodiment, even in a case in which the determination for S1008 is not performed, and either of real-time distribution or scheduled distribution has been selected during S1001, during S1009, the selection of whether or not to automatically acquire the latest firmware is received from the user on the distribution setting screen. FIG. 12C is a diagram showing a distribution setting screen in the present embodiment for a case in which real-time distribution has been selected. Although in the First Embodiment it was made such that the automatic acquisition setting item 1203 could not be selected on the distribution setting screen 1200 in a case in which real-time distribution had been selected, in the present embodiment, the automatic acquisition setting item 1203 is displayed on the distribution setting screen 1220 so as to selectable even in a case in which real-time distribution has been selected.

If it is determined during S1004 that this is not scheduled distribution, the function display unit 303 displays the real-time distribution confirmation screen. FIG. 17B is a diagram showing one example of a real-time distribution confirmation screen in the present embodiment. The target device for the update that was set during S1012, and the on/off for the automatic acquisition of the latest firmware are displayed on the real-time distribution confirmation screen 1700. Upon the user pressing down an update button 1711 on the real-time distribution confirmation screen 1710, the firmware distribution unit 332 performs the processing for S1007.

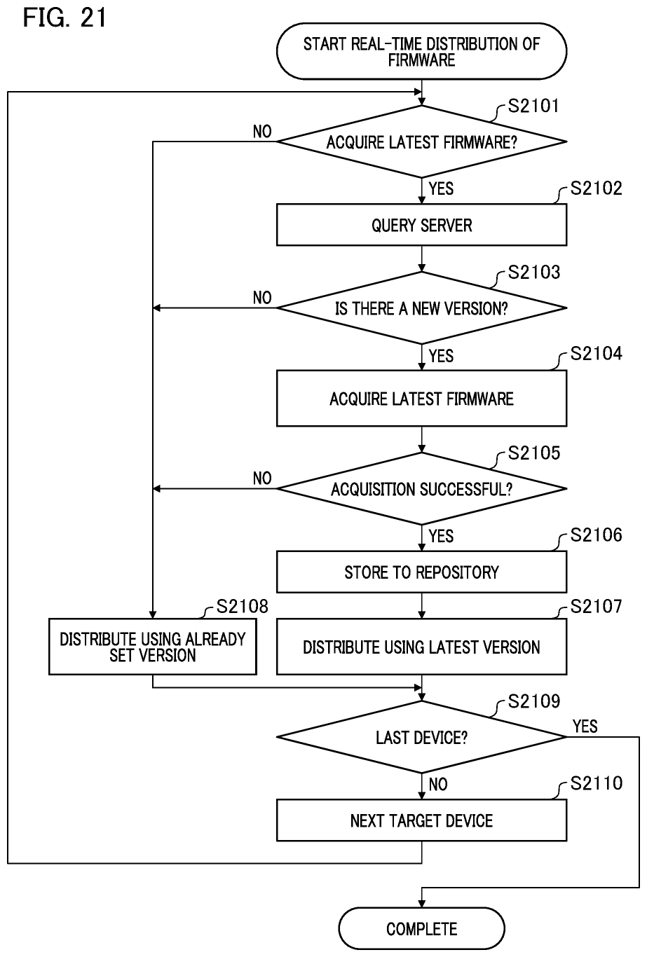

In this context, the details for the processing for the real-time distribution of firmware (S1007) in the present embodiment will be explained. FIG. 21 is a flowchart showing the real-time firmware distribution processing in the Third Embodiment. Note that the real-time firmware distribution processing is realized by the CPU 10 of the device management server 1000 executing a program that has been stored on a memory (the ROM 11 or the HDD 19).

During S2101, the firmware distribution unit 332 determines if the settings to acquire the latest firmware were received during S1009. In a case in which it has been determined that the setting to acquire the latest firmware was received, the processing proceeds to S2102. In a case in which it has been determined that the settings to acquire the latest firmware were not received, the processing proceeds to S2108. During S2102, the firmware distribution unit 332 queries the content management server 4000 via the firmware acquisition unit 331. The firmware distribution unit 332 performs a query about if there is a newer version of the firmware based on the product name for the device that is the update target that was selected during S1003 and the version of the firmware. During S2103, the firmware distribution unit 332 determines whether or not there is a newer version of the firmware based on the results of the query from S2102. In a case in which it has been determined that there is a newer version of the firmware, the processing for S2104 is performed. In contrast, in a case in which it has been determined that there is not a newer version of the firmware, the processing for S1207 is performed.

During S2104, the firmware acquisition unit 331 performs the acquisition of the new version of the firmware from the content managing server 4000. During S2105, the firmware acquisition unit 331 determines whether or not the acquisition of the firmware during S2104 was successful. In a case in which it has been determined that the acquisition of the firmware was successful, the processing for S2106 is performed In contrast, in a case in which it has been determined that the acquisition of the firmware was not successful, the processing for S2107 is performed, During S2106, the firmware acquisition unit 331 stores the firmware that has been newly acquired from the content management server 4000 on the repository 334. During S2107, the firmware distribution unit 332 performs the distribution of firmware to the device using the new version of the firmware that was acquired during S2104 and stored on the repository 334 during S2106.

In contrast, during S2108, the firmware distribution unit 332 does not perform the automatic acquisition of the latest firmware, and performs the distribution of the firmware to the device using the version of the firmware that was set during S1003. During S2109, the firmware distribution unit 332 determines if the device that is the current update target is the last device that has been set as an update target during S1003. In a case in which it has been determined to be the last device, the present processing is completed. In contrast, in a case in which it has been determined that there are devices that were set as update targets during S1003 that are yet to be updated, the processing for S2110 is performed. During S2110, the firmware distribution unit 332 indicates the next device that was selected as an update target, and the processing returns to S2101. According to the above automatic acquisition of the latest firmware at the time of real-time distribution, in the present embodiment, it is possible to acquire and store the latest firmware on the repository 334 and distribute this to the device in the same manner as for the scheduled distribution in the First Embodiment, even for real-time distribution.

In this manner, according to the present embodiment, in a case in which the distribution of the firmware is not scheduled, that is, for real-time distribution as well, it is made possible to provide an automatic acquisition option for the latest firmware. In addition, it can be made possible to update the device using the latest firmware at the time of real-time distribution.

### Fourth Embodiment

In the First Embodiment, even in a case in which the automatic acquisition of the latest firmware at the time of scheduled distribution has been set, during S1013, the firmware corresponding to the device that is the target of the firmware update that has already been acquired in the repository 334 was displayed. However, in a case in which the latest firmware will be automatically acquired then distributed, it will become such that the firmware that was displayed during S1013 is not distributed. In this context, in the present embodiment, in a case in which the automatic acquisition of the latest firmware at the time of scheduled distribution has been set, it is made such that the display of firmware that has already been acquired in the repository 334 is not performed during S1013. Note that in the present embodiment, only the differences from the First Embodiment will be explained.

In the present embodiment, the processing that is shown in FIG. 10B is performed during S1003. FIG. 10B is a flowchart showing the firmware update setting processing in the Third Embodiment. During S1012, in the same manner as in the First Embodiment, the function display unit 303 lists the devices that have already been searched for by the device management unit, and receives the selection of which device the firmware update will be performed for from the user. In addition, after the processing for S1012, the processing for S1020 is performed.

During S1020, the firmware distribution unit 332 determines if settings for the automatic acquisition of the latest firmware were received during S1009. In a case in which it has been determined that a settings was received for the automatic acquisition of the latest firmware, the present processing is completed, and the flow returns to the processing for S1004 that is shown in FIG. 8. In contrast, in a case in which it has been determined that setting for the automatic acquisition of the latest firmware has not been received, the processing for S1013 is performed. The contents of the processing for S1013 are the same as those in the First Embodiment. In a case in which the setting for the automatic acquisition of the latest firmware has not been received, that is, in a case in which the update will be performed with the firmware that has already been stored on the current repository 334, the function display unit 303 displays the firmware that has already been acquired on the repository 334 that can be applied to the device that has been selected. In addition, the selection of the firmware from the user is received. Therefore, the firmware selection screen 1400 that is shown in FIG. 14 is only displayed in cases in which settings have not been received for the automatic acquisition of the latest firmware, and it is not displayed in cases in which a setting has been received for the automatic acquisition of the latest firmware.

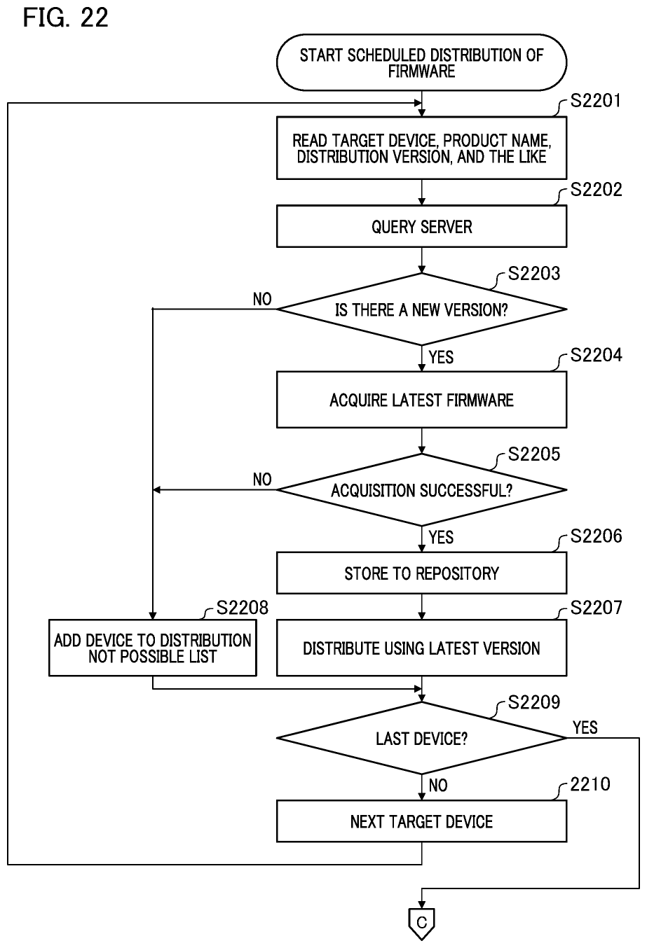

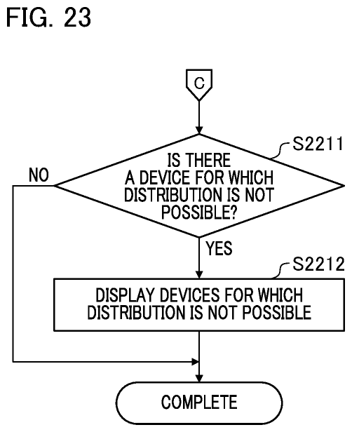

Next, the processing for executing a task in the present embodiment will be explained. FIG. 22 and FIG. 23 are flowcharts showing the processing for executing a task to distribute firmware in the Fourth Embodiment. Note that in FIG. 22 and FIG. 23 the differences with the First Embodiment will be explained, and therefore, only a case in which the setting for the automatic acquisition of the latest firmware has been received will be explained. In a case in which the setting for the automatic acquisition of the latest firmware has not been received, in the same manner as in S1109 of the First Embodiment, the update for the device will be executed using a firmware version that has already been set during S1013. Note that the processing for executing a schedule for the firmware distribution is realized by the CPU 10 of the device management server 100 executing a program that has been stored on a memory (the ROM 11 or the HDD 19).

During S2201, the firmware distribution unit 332 performs the reading of the target device for which the firmware distribution will be performed, the product name, the distribution version, the settings for the acquisition of the latest firmware, and the like. During S2202, the firmware distribution unit 332 queries the content management server 4000 about the latest version of the firmware via the firmware acquisition unit 331. The firmware distribution unit 332 performs a query about if there if a version of the firmware that is newer than this version based on the product name and version that were acquired during S2201.

During S2203, the firmware distribution unit 332 determines if there is a newer version of the firmware based on the results of the query from S2202. In a case in which it has been determined that there is a newer version of the firmware, the processing for S204 is performed. In contrast, in a case in which it has been determined that there is not a newer version of the firmware, the processing for S2208 is performed.

In a case in which there is a new version of the firmware, during S2204, the firmware acquisition unit 331 performs the acquisition of the new version of the firmware. During S2205, the firmware acquisition unit 331 determines if the acquisition of the firmware during S2204 was successful. In a case in which it has been determined that this was successful, the processing for S2206 is performed. In contrast, in a case in which it has been determined that this was not successful, the processing for S2208 is performed. During S2206, the firmware acquisition unit 331 performs the storage of the firmware that was acquired during S2204 to the repository 334. During S2207, the firmware distribution unit 332 performs the distribution of firmware to the device using the new version of the firmware that was acquired during S2204 and stored during S2206.

In a case in which there is no new version of the firmware, or in a case in which the acquisition of the new firmware has failed, the processing for S2208 is performed. During S2208, the firmware distribution unit 332 stores the device that is the target for the firmware update during the current processing as a device for which distribution is not possible in the device data storage unit 313 via the device data management unit 312.

During S2209, the firmware distribution unit 332 determines if the device that has been selected as the update target is the last device that is a firmware update target device that has been indicated by the task. In a case in which it has been determined that this is the last device, the processing for S2211 is performed. In contrast, in a case in which it has been determined that this is not the last device, the processing proceeds to S2210. During S2210, the firmware distribution unit 332 indicates the next device that has been selected as an update target, and the processing returns to S2201.

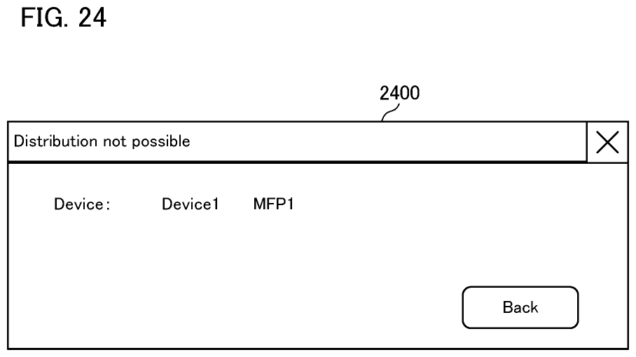

During S2211, the function display unit 303 determines if there are any devices for which distribution is not possible. The function display unit 303 determines if there are any devices for which distribution is not possible based on the information that is stored on the device data storage unit 313. In a case in which it has been determined that there are devices for which distribution is not possible, the processing for S2212 is performed. In contrast, in a case in which it has been determined that there are no devices for which distribution is not possible, the present processing is completed. During S2212, the function display unit 303 performs the display of a list of the devices for which distribution is not possible, and the present processing is completed. One example of a screen that is displayed during S221 is shown in FIG. 24. FIG. 24 is a diagram showing one example of a devices for which distribution is not possible screen. A list of device information for the devices that have been made devices for which distribution is not possible during S2208 is displayed on the devices for which distribution is not possible screen 2400. For example, the device names and the product names of the devices to which the firmware could not be distributed are displayed as device information on the devices for which distribution is not possible screen. The function display unit 303 provides the user with the information for the devices for which distribution is not possible by displaying the list of the devices for which distribution is not possible.

According to the present embodiment that is described above, when the automatic acquisition of the latest firmware has been set, it is made possible to not display and select the firmware inside of the repository that has already been acquired at the time at which the schedule was indicated. It is thereby possible to reduce the selections and settings that are required from the user in the setting of an update schedule for firmware when the automatic acquisition of the latest firmware has been set.

### Other Embodiments

Note that even if the present invention is applied to a system that is configured from a plurality of devices (for example, a host computer, an interface device, a reader, a printer, or the like), it may also be applied to an apparatus that consists of one device (for example, a photocopying machine, a fax machine, or the like). In addition, the goal of the present invention is to supply a system or an apparatus with a recording medium on which a program code that executes the functions of the above-described embodiments has been recorded, and this can also be achieved by a computer program of this system or apparatus reading out and executing a program code that has been stored on a storage medium. In this case, it becomes such that the program code that has been read out from the storage medium itself realizes the functions of the above-described embodiment, and it becomes such that this program code itself and the storage medium on which this program code has been stored configure the present invention.

In addition, the present invention also includes cases in which a portion or the entirety of the actual processing is performed by an operating system (OS) that operates on a computer, or the like, and the functions of the above-described embodiments are realized by this processing based on commands from the program code. Furthermore, the present invention may also be applied to cases in which a program code that has been read out from a storage medium has been written onto a function expansion card that has been inserted into a computer or a memory that is provided with a function expansion unit that is connected to a computer. In this case, a portion or the entirety of the actual processing is performed by a CPU or the like that this function expansion card or function expansion unit is provided with, and the functions of the above-described embodiments are realized by this processing based on the commands of the program code that has been written thereon.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-040226, filed Mar. 15, 2023, which is hereby incorporated by reference wherein in its entirety.

What is claimed is:

1. A management apparatus comprising:
a memory storing instructions; and
a processor executing the instructions causing the management apparatus to:
acquire firmware that has been selected on a selection screen for firmware comprising device information for image processing apparatuses;
store the firmware that has been acquired on a designated storage destination;
receive a first command for an update for firmware of an image processing apparatus;
receive a second command for setting a schedule for the update;
receive a setting to automatically acquire latest firmware at a timing of the update in accordance with the schedule when the second command has been received; and
automatically acquire latest firmware that should be distributed to the image processing apparatus based on the setting to automatically acquire the latest firmware at the timing of the update according to the schedule,
wherein the processor is able to acquire firmware that has not yet been stored on the storage destination at the timing of the update according to the schedule.

2. The management apparatus according to claim 1, wherein
the processor receives a setting to automatically acquire the latest firmware, and a setting to delete the latest firmware that was acquired; and
the latest firmware that was automatically acquired and stored on the storage destination is deleted after it has been distributed to the image processing apparatus based on the setting to automatically acquire the latest firmware at the timing of the update according to the schedule.

3. The management apparatus according to claim 1, wherein the processor further executes an instruction causing the management apparatus to:
receive a setting for an update to firmware of an image processing apparatus; and
update the firmware by distributing the firmware to the image processing apparatus,
wherein, when the setting for the update to the firmware of the image processing apparatus is received, the processor displays a list of image processing apparatuses that are being managed, and receives a selection of an image processing apparatus for which the firmware will be updated, displays firmware corresponding to the image processing apparatus that is stored on the storage destination, and receives a selection of firmware to be distributed to this image processing apparatus; and
wherein, based on the setting to automatically acquire the latest firmware at the timing of the update according to the schedule, in a case in which the latest firmware that has been automatically acquired exists, the processor distributes the latest firmware to the image processing apparatus, and in a case in which the latest firmware does not exist, the processor distributes firmware that is stored on the storage destination and that has been selected in the setting for the update to the firmware that have been received to the image processing apparatus.

4. The image processing apparatus according to claim 1, wherein the processor further executes an instruction causing the management apparatus to:
receive a setting for an update to firmware of an image processing apparatus; and
update the firmware by distributing the firmware to the image processing apparatus;
wherein, when the setting for the update to the firmware of the image processing apparatus is received, in a case in which a setting for automatically acquiring the latest firmware is also received, the processor displays a list of image processing apparatuses that are being managed, only receives an indication of an image processing apparatus for which the firmware will be updated, and does not display firmware that is stored on the storage destination; and
wherein, based on the setting to automatically acquire the latest firmware at the timing of the update according to the schedule, in a case in which the latest firmware has been automatically acquired, the processor distributes the latest firmware to the image processing apparatus, and in a case in which the latest firmware has not been acquired, does not distribute firmware to the image processing apparatus.

5. The management apparatus according to claim 4, wherein the processor further executes an instruction causing the management apparatus to:
provide a list with this image processing apparatus, in a case in which a setting to automatically acquire the latest firmware is received, in a case in which the processor was not able to acquire the latest firmware that should be distributed to an image processing apparatus.

6. The management apparatus according to claim 1, wherein the processor further executes an instruction causing the management apparatus to:
receive a setting to automatically acquire latest firmware when a command for an update to firmware in real-time has been received; and
automatically acquire firmware that should be distributed to the image processing apparatus in real-time based on the setting to automatically acquire the latest firmware.

7. A control method for a management apparatus, the method comprising:
acquiring firmware that has been selected on a selection screen for firmware comprising device information for image processing apparatuses;
storing the firmware that has been acquired on a designated storage destination;
receiving a first command for an update to firmware of an image processing apparatus;
receiving a second command for setting a schedule for the update;
receiving a setting to automatically acquire latest firmware at a timing of the update in accordance with the schedule when the second command has been received; and
automatically acquiring the latest firmware that should be distributed to an image processing apparatus based on the setting to automatically acquire the latest firmware at the timing of the update according to the schedule,
wherein it is possible to acquire firmware that has not yet been stored on the storage destination at the timing of the update according to the schedule.

8. A non-transitory storage medium storing a control program of a management apparatus causing a computer to perform each step of a control method for the management apparatus, the method comprising:
acquiring firmware that has been selected on a selection screen for firmware comprising device information for image processing apparatuses;
storing the firmware that has been acquired on a designated storage destination;
receiving a first command for an update to firmware of an image processing apparatus;
receiving a second command for setting a schedule for the update;
receiving a setting to automatically acquire latest firmware at a timing of the update in accordance with the schedule when the second command has been received; and
automatically acquiring the latest firmware that should be distributed to an image processing apparatus based on the setting to automatically acquire the latest firmware at the timing of the update according to the schedule,
wherein it is possible to acquire firmware that has not yet been stored on the storage destination at the timing of the update according to the schedule.
